(19) United States
(12) Patent Application Publication
(10) Pub. No.: US 2024/0272786 A1
(43) Pub. Date: Aug. 15, 2024

(54) SCROLLING USER INTERFACE SYSTEM AND METHOD

(71) Applicant: James Trevor McDonald, Crane, TX (US)

(72) Inventor: James Trevor McDonald, Crane, TX (US)

(21) Appl. No.: 18/109,758

(22) Filed: Feb. 14, 2023

(51) Int. Cl. G06F 3/0485; G06F 3/0488

(52) U.S. Cl. CPC G06F 3/0485; G06F 3/0488

(57) ABSTRACT

A scrolling control system, which may include a user input device including a touch sensitive screen, an analysis system responsive to user manipulation of the touch screen to enter and control a scrolling mode, the speed and direction of the scrolling mode speed determined by comparing an initial feedback location with a subsequent feedback location from the touch sensitive screen, and a verification system that uses captured inputs from the user input device to determine if a user is using the input device.

### BACKGROUND OF THE INVENTION

### Field of the Invention

The present invention relates generally to user interfaces for actuated navigation of electronic devices, specifically to improve scrolling on touch screen enabled devices.

### Description of the Related Art

User content is now viewable on user devices lacking peripheral inputs, which instead rely on various touch screen technologies. Such content now includes continuous-feed programs, which have no end and allow a user to keep consuming content seemingly endlessly. Such content is continuously accessible via a user repeatedly manipulating the touch screen with their finger(s) in order to move through the feed.

As many of these applications are free or relatively inexpensive, published content is used to generate income for the creator(s) or owner(s) of the application. Generally, an account is required to view the content, in order to limit spam bots and viewer boosting programs. Such accounts provide verification of the user's authenticity and oftentimes need to be signed into or require substantial amounts of personal information, in order to create or verify.

Accordingly, these applications automatically consider content viewed while a signed-in account hits against the published content. Publishers rely on these methods to know that users are actually consuming their content, and although the requirement is to sign-in, this is a low level of intrusiveness for the user once set up. Examples of references related to the present invention are listed below, and the supporting teachings of each reference are incorporated by reference.

U.S. patent Ser. No. 10/628,023, to Choi, discloses a method for controlling a mobile terminal. The method includes displaying an operation screen on a display unit, receiving a touch input for a predetermined time on the display unit, and scrolling the operation screen in a direction corresponding to a location of the display unit where the touch input is received.

U.S. Pat. No. 6,972,749, to Hinckley, et al., discloses a touch-sensitive device for use as an electronic input device for controlling by scrolling the visible portion of a document or image relative to a display. The device can include various improved configurations such as physically separate opposed input surfaces at opposite longitudinal ends and/or lateral sides. The end regions of a touch sensitive surface may be rounded and/or tapered to provide relative positional feedback to the user. Tactile positional feedback can also include surface texture changes on the scrolling area and/or changes in the surface of the frame in the region immediately adjacent the scrolling area. The touch sensitive areas may be provided within a split alphanumeric section of an ergonomic keyboard to enable scrolling without the user having to remove his or her hands from the alphanumeric section.

US Patent Application No. 20100088632, to Knowles et al. discloses a method and touchscreen-based handheld electronic device having dual navigation modes are provided. In accordance with one embodiment, there is provided a handheld electronic device, comprising: a controller; a touchscreen display connected to the controller; the controller being configured for displaying on the touchscreen display a graphical user interface (GUI) having a display area defined by a boundary; and the controller being configured for providing a cursor navigation mode and a pan navigation mode, and for switching between the cursor navigation mode and the pan navigation mode in response to respective input.

U.S. Pat. No. 9,262,002, to Momeyer et al., discloses a computing device includes a touch screen display with a plurality of force sensors, each of which provides a signal in response to contact with the touch screen display. Using force signals from the plurality of force sensors, a characteristic of the contact is determined, such as the magnitude of the force, the centroid of force and the shear force. The characteristic of the contact is used to select a command which is processed to control the computing device. For example, the command may be related to manipulating data displayed on the touch screen display, e.g., by adjusting the scroll speed or the quantity of data selected in response to the magnitude of force, or related to an operation of an application on the computing device, such as selecting different focal ranges, producing an alarm, or adjusting the volume of a speaker in response to the magnitude of force.

U.S. Pat. No. 9,152,258, to Behdasht et al., discloses a non-transitory computer readable medium storing instructions which, when executed by a processor of an electronic device that includes a touch sensitive and pressure sensitive display, cause the processor to enable a user interface of the electronic device, by which a glide gesture along the display and an amount of pressure applied to the display both generate the same user interface command.

U.S. Pat. No. 7,071,919, to Hinckley et al., discloses a method and system for electronically scrolling a document with a data processing apparatus uses an input device, e.g., a mouse, to permit position based scrolling without first accessing a scroll bar or other scrolling functionality element. In a page positional scrolling (PPS) mode useful for scrolling short distances, a displayed document is scrolled one pixel per one pixel of motion of the mouse. In a second mode (document positional scrolling—DPS), the document is scrolled a distance per pixel of mouse movement corresponding to the ratio of the document length (or width) to the page length (or width). In a further embodiment (smoothed document positional scrolling-SDPS), as the mouse is moved away from a starting position the system begins scrolling in PPS, transitions smoothly from PPS to DPS, and then continues to scroll in DPS.

WO Patent Application Publication No. 2001029815, to Woolley, discloses a simplified touchpad (21) which detects a ‘touch’ in a specific absolute positioning programmable zone or ‘enter/select’ zone (29) rather than requiring a ‘tap’. The touchpad (21) also has an audible feedback device built into the touchpad (21) for immediate feedback and a touch sensitive surface (26) comprising a relative cursor positioning zone (27). By simplifying a touchpad to include only basic functions, the touchpad (21) is easier to operate, simpler to manufacture, and more amenable to use with graphical interface display systems typically using touch screens (25).

The inventions heretofore known suffer from a number of disadvantages, including but not limited to: being an unnatural process, not retaining the finger(s) in a natural position to scroll, requiring excessively complex technology, being difficult to control, unintuitive to use, not being ergonomic, highly uncomfortable to use, interfering with remaining device components or software, requiring multiple movements or lifting off the screen, and being difficult to implement or remove.

What is needed is a system and/or method that solves one or more of the problems described herein and/or one or more problems that may come to the attention of one skilled in the art upon becoming familiar with this specification.

### SUMMARY OF THE INVENTION

There may be a scrolling control system, which may include a user device that may include a touch sensitive screen, an analysis system which may be responsive to user manipulation of the touch screen and may enter and control a scrolling mode, the speed and direction of the scrolling mode speed may be determined by comparing an initial feedback location with a subsequent feedback location from the touch sensitive screen, and a verification system that may use captured inputs from the user device to determine if a user is using the input device, the user device may further include one or more input devices which may be chosen from an accelerometer, a camera, and a gyroscope, the verification system may use the input device feedback as the captured input, the user device may include each of an accelerometer, a camera, and a gyroscope, the verification system using the combined inputs from each as the captured input, the verification system may flag the input device if it determines a user is not using the scrolling control system, the analysis system may enter the scrolling mode upon the sensing an initial touch on the touch sensitive screen, the analysis system may maintain the scrolling mode only while feedback from the touch screen is present and exits the scrolling mode upon sensing no feedback from the touch screen, speed of the scrolling may increase exponentially with the distance between the initial touch location and the subsequent touch location, and the analysis system may be only responsive to user manipulation on a predetermined section of the touch sensitive screen.

Further, there may be a method for electronic scrolling, which may include detecting an initial input on a user device through a touch sensitive screen, storing the initial input location, detecting a subsequent input on another location of the touch sensitive screen, determining a scroll rate based on the distance between the initial input and subsequent input, electronically scrolling the information displayed on the touch sensitive screen, detecting an absence of an input on the touch sensitive screen, and stopping the scrolling, the step of determining if a user is using the user device may be done by capturing an input from the user device, also including erasing the stored initial input location, further including the step of using an input device to determine if a user is using the user device, choosing an input device is from one or more of an accelerometer, a camera, and a gyroscope, and where the scroll rate may exponentially increases with the distance between the initial input and subsequent input.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of a scrolling user-interface system, according to one embodiment of the invention;

FIG. 2 is a component diagram of a scrolling user-interface system, according to one embodiment of the invention;

FIGS. 3 and 4 illustrate a hand-held electronic device having a scrolling user-interface system in operation, according to one embodiment of the invention;

FIG. 5 is a module diagram of a scrolling user-interface system, according to one embodiment of the invention;

FIG. 6 is a flowchart of a scrolling user-interface system in operation, according to one embodiment of the invention;

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The various system components and/or modules discussed herein may include one or more of the following: a host server, motherboard, network, chipset or other computing system including a processor for processing digital data; a memory device coupled to a processor for storing digital data; an input digitizer coupled to a processor for inputting digital data; an application program stored in a memory device and accessible by a processor for directing processing of digital data by the processor; a display device coupled to a processor and/or a memory device for displaying information derived from digital data processed by the processor; and a plurality of databases including memory device(s) and/or hardware/software driven logical data storage structure(s).

Various databases/memory devices described herein may include records associated with one or more functions, purposes, intended beneficiaries, benefits and the like of one or more modules as described herein or as one of ordinary skill in the art would recognize as appropriate and/or like data useful in the operation of the present invention.

As those skilled in the art will appreciate, any computers discussed herein may include an operating system, such as but not limited to: Android, IOS, BSD, IBM z/OS, Windows Phone, Windows CE, Palm OS, Windows Vista, NT, 95/98/2000, OS X, OS2; QNX, UNIX; GNU/Linux; Solaris; MacOS; and etc., as well as various conventional support software and drivers typically associated with computers. The computers may be in a home, industrial or business environment with access to a network. In an exemplary embodiment, access is through the Internet through a commercially-available web-browser software package, including but not limited to Internet Explorer, Google Chrome, Firefox, Opera, and Safari.

The present invention may be described herein in terms of functional block components, functions, options, screen shots, user interactions, optional selections, various processing steps, features, user interfaces, and the like. Each of such described herein may be one or more modules in exemplary embodiments of the invention even if not expressly named herein as being a module. It should be appreciated that such functional blocks and etc. may be realized by any number of hardware and/or software components configured to perform the specified functions. For example, the present invention may employ various integrated circuit components, e.g., memory elements, processing elements, logic elements, scripts, look-up tables, and the like, which may carry out a variety of functions under the control of one or more microprocessors or other control devices. Similarly, the software elements of the present invention may be implemented with any programming or scripting language such as but not limited to Eiffel, Haskell, C, C++, Java, Python, COBOL, Ruby, assembler, Groovy, PERL, Ada, Visual Basic, SQL Stored Procedures, AJAX, Bean Shell, and extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units, third party devices/systems and/or modules. Being “in communication” refers to any manner and/or way in which functional units and/or modules, such as, but not limited to, computers, networks, mobile devices, program blocks, chips, scripts, drivers, instruction sets, databases and other types of hardware and/or software, may be in communication with each other. Some non-limiting examples include communicating, sending, and/or receiving data and metadata via: a wired network, a wireless network, shared access databases, circuitry, phone lines, internet backbones, transponders, network cards, busses, satellite signals, electric signals, electrical and magnetic fields and/or pulses, and/or so forth.

These features and advantages of the present invention will become more fully apparent from the following description and appended claims or may be learned by the practice of the invention as set forth hereinafter.

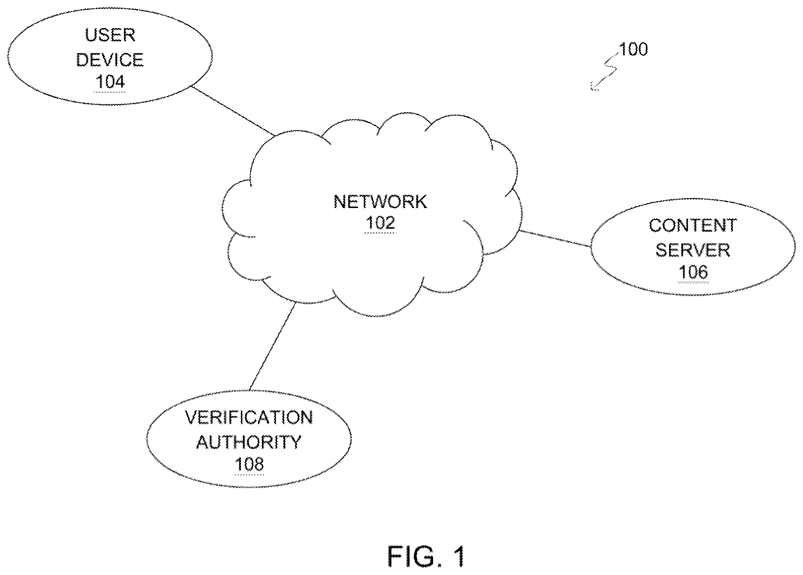

FIG. 1 is a network diagram of a scrolling user-interface (SUI) system 100, according to one embodiment of the invention. There is shown a network 102 functionally connecting each of: a user device 104, content servers 106, and a verification authority 108. Advantageously, the SUI system 100 allows a user to scroll on the user device while also verifying that it is indeed an actual user interacting with the device such that the content has verified human interaction. Advantageously, the SUI provides scrolling functionality to users that is simple and efficient to use, wherein scrolling speed and direction is controlled via a touch and slide operation, the speed and direction being determined by a measurement of the direction and distance of the slide.

The illustrated network 102 includes any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Further, the network may be a wireless ad hoc network.

Moreover, although the invention may be implemented with TCP/IP communications protocols, the invention may also be implemented using other protocols, including but not limited to IPX, Appletalk, IP-6, NetBIOS, OSI or any number of existing or future protocols. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

The illustrated user device 104 is an electronic device, generally hand-held, that includes a touch sensitive screen (touch screen) for user input and content output. The illustrated device has functional network connectivity, though embodiments are envisioned where the device does not have network connectivity yet still includes the SUI. The illustrated user device 104 is functionally connected to the content servers 106 and verification authority 108 through the network and is responsible for sending and receiving information as well as displaying information to the user. The user device 104 shown includes one or more user interfaces which include a graphical user interface (GUI) and may include devices and programming sufficient to communicate with/over a network, to display data, and to allow for interactive controls (e.g. buttons, data entry). Generally, such may be in the form of a personal computer, dumb-terminal, smartphone, tablet, or the like, but other embodiments are contemplated. Such devices may be capable of both audio and visual outputs.

The illustrated content servers 106 host and/or provide content accessible to user device(s). Such may include web servers, application servers, remotely accessible data storage devices, intranet content hosts, and the like and combinations thereof. The content provided may include text, audio, graphical, data, applications, and the like. Such may also include functional components of the user interface system described herein, such as but not limited to one or more applications that may be downloaded into the user device to provide the user interface functionality across content received from other sources, portions of code configured to provide user interface functionality only for content provided therewith, and the like and combinations thereof.

The illustrated content servers 106 are shown functionally connected to the user device 104 through the network 102. The content servers 106 are websites, applications, and the like which are accessible to user through the user device 104. In some embodiments, the content servers 106 may include the SUI system such that the user device 104 is able to use the SUI system only while on that specific content server 106, rather than the SUI system remaining on the user device 106.

The illustrated verification authority 108 receives information from the user device 104 verifying that a user has been determined to be using the user device 104. Accordingly, the verification authority 108 may accurately determine and report user interaction or usage statistics such as time stamped lengths of interaction and direction or speed of scrolling performed. For example, the information collected could be an amount of time the user activates the SUI through touch contact with the user device while holding the device at a predetermined angle from a horizontal surface perpendicular to the direction of a force of gravity. Such could be flagged as suitable human interaction. On the contrary, another example is where the user device activates the SUI through touch contact and held at another angle which is outside of a predetermined angle range, or the user device is not returning any acceleration while sensing the SUI in activation mode. Such could be flagged as unsuitable human interaction.

This allows content providers or advertisers to know how often their content has verified human interaction. The verification authority may be associated with a third-party content provider who desires to track and/or verify how/when content has verified human interaction and for what lengths of time (e.g. filtering bot traffic from real human viewers).

In other embodiments, the verification authority 108 may also include a login/authentication manager which restricts access to the content servers and the usage of the SUI system on the user device, or in some embodiments, to specific aspects of an account administration system, to those with valid credentials (e.g. user name and password, biometrics, security certificates). Such may include an RSA authentication manager, such as but not limited to RSA SecureID by RSA Security LLC of Bedford MA.

Advantageously, the illustrated system provides a user interface that has multiple modes of installation/operation and that is capable of functional benefits to more than just the operation of the user device itself. The system allows for the SUI to be provided to the user device in whole (e.g. via a single application that may be utilized with third-party content). The system also allows for the scrolling interface to be delivered in parts and/or packaged with content such that the functionality is allowed with specific content but not available with third party content.

In use, the SUI assists with creating a more natural physical action for the touch screen user. In order to continually receive more content, the user would otherwise be required to repeat physical movements with finger(s) that are uncomfortable. Such motions and repetitions are intrusive to the touch screen user experience by hindering a touch screen user's physical dexterity endurance.

Accordingly, the SUI is more ergonomic than the standard scrolling method as well as the corresponding derivatives of the standard scrolling method, as the latter are complex and continue to interfere with the touch screen software/components/user experience. The standard scrolling method derivatives have different processes that require downloads, logins, and extreme measures to initiate such as pressing with force, shaking, tapping, or flipping back and forth of the touch screen device. Once these are implemented, the touch screen user also has no other available options to use the standard manual “flicking” to scroll alongside the pressing with force, shaking, tapping, or flipping back and forth of the touch screen. This leaves no complete control of content scrolling by the touch screen user in the form of speed, angle, and ergonomics, producing the lack of a user-friendly experience.

Finally, the standard scrolling method has no availability for continuous proof of interaction of content by a human being. Any data analytics done by a publisher through the current scrolling method is not completely accurate content analytics. This leaves a touch screen user being bombarded with intrusive content (i.e., ads, surveys, etc). Whereby proven human interaction data is more valuable, and the content publisher may keep the touch screen user anonymous.

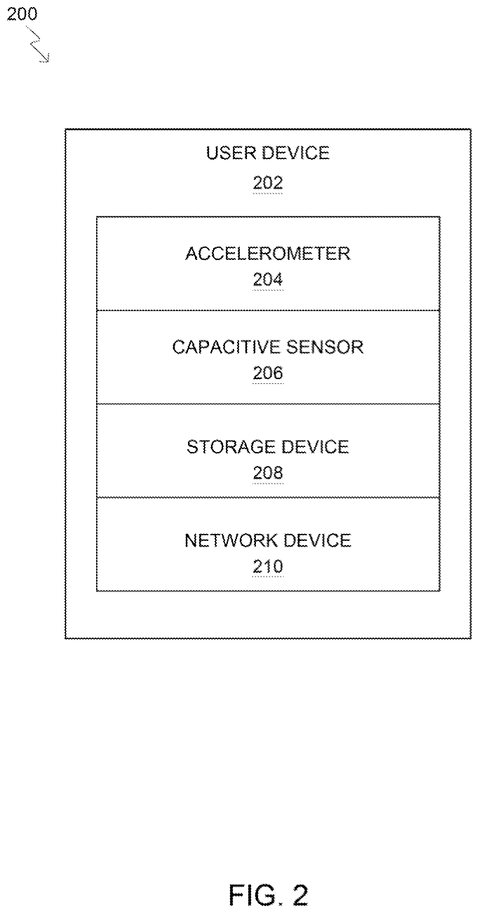

FIG. 2 is a component diagram of a SUI system, according to one embodiment of the invention. There is shown a user device 202 including each of: an accelerometer 204, capacitive sensor 206, storage device 208, and network device 210. Accordingly, the SUI system 200 may enable scrolling on the user device 202 using a single finger, or even multiple fingers, without blocking content, regardless of location on the user device 202.

The illustrated user device 202 may incorporate each of the accelerometer 204, capacitive sensor 206, storage device, and network device 210, or may simply serve as a functional connector such that each of the components may communicate with one another. Such may be in the form of a personal computer, dumb-terminal, smartphone, tablet, or the like, but other embodiments are contemplated. Such devices may be capable of audio, visual, and haptic outputs.

Such will generally include a processor, a display device (e.g. monitor, tv, touchscreen), an audio device (e.g. speaker, microphone), memory, a bus, a user input device (e.g. controller, keyboard, mouse, touchscreen), and a communication device (e.g. a network card, wireless transponder), each in communication with one or more of the others as appropriate for the function thereof, generally over the bus and/or network. As those skilled in the art will appreciate, any computers discussed herein may include an operating system, such as but not limited to: Android, IOS, BSD, IBM z/OS, Windows Phone, Windows CE, Palm OS, Windows Vista, NT, 95/98/2000, OS X, OS2; QNX, UNIX: GNU/Linux; Solaris; MacOS; and etc., as well as various conventional support software and drivers typically associated with computers. The computers may be in a home, industrial or business environment with access to a network 210. In an exemplary embodiment, access is through the Internet through a commercially-available web-browser software package, including but not limited to Internet Explorer, Google Chrome, Firefox, Opera, and Safari.

The illustrated accelerometer 204 is functionally connected to the user device 202 and tracks movement of the user device 202. The accelerometer 204 is generally an electromechanical device used to measure acceleration forces. The measured forces may be static, such as the continuous force of gravity or, in other cases, the measured forces may be dynamic, such as is the case with many mobile devices, sense movement or vibrations.

They accelerometer 204 generally operates using piezoelectric sensors and/or capacitive sensors 206 that react to acceleration and provide a voltage or change in voltage in relation to the amount of acceleration. These sensors are generally provided on multiple axis so that the direction of acceleration is known, not just the amount. Where the accelerometer 204 measures the static gravitational acceleration, the orientation of the device in relation to the direction of gravity can be known. This allows an observer to know the tilt of the device. By implication, one can observe tilting and changes in tilt that indicate if the object is resting on a flat surface (e.g. a table) or if the device is being held by a user (e.g. tilted for viewing together with very small acceleration due to tremors or shifting positions of the user's hand).

In other embodiments, the accelerometer 204 may not be the only sensor used by the user device 202. Other input devices, such as fingerprint scanners, cameras, gyroscopes, and the like and combinations thereof may be used to collect information about the phone and/or to verify a user is using the user device 202.

Accordingly, an SUI system may prevent usage of the system if the device is not being held within an angle range (e.g. between two of about 5, 10, 15, 20, 25, 30, 35, 40, 45, 50, 55, 60, 65, 70, 75, 80, 85 degrees from level with gravity) and/or if the device does not show small accelerations due to being held in the hand of a user. Alternatively, the content may still scroll as desired, but the analytic data associated therewith may be flagged so that it is treated differently (e.g. no pay-per scroll since the view was not verified as being with a live person).

The illustrated capacitive sensor 206 is functionally connected to the user device 202 and allow the SUI system 200 to register any number of touches and/or slides from a user. Such capacitive sensor 206 are generally incorporated into the user device 202 as a touch screen, however in other embodiments, may be resistive sensors or the like. The capacitive sensor 206 may be located anywhere on the user device 202 or a peripheral device functionally connected to the user device 202. In one non-limiting embodiment, the capacitive sensor 206 allows the user interface to produce an ongoing scrolling effect in the displayed content in reaction to an electronic scrolling action by a user's finger(s) being detected by the capacitive sensor 206, wherein the speed of the ongoing scrolling is proportional, exponential, logarithmic, or otherwise calculated based on a distance of the slide of the finger from the original touch position observed by the capacitive sensor 206. In alternative embodiments, the capacitive sensor may be a sensor other than the one on the touch screen of the user device. Such a screen may not be a screen at all, rather it may be simply an input and have no output. The capacitive sensor may be fully detached from the user device entirely, such that it may only be functionally connected to the output of the user device.

The illustrated storage device 208 is functionally connected to the user device 202 and is used to contain the SUI software as well as any information, profiles, or settings submitted by or collected from the user. Data storage systems/devices described herein may include databases and/or data files. There may be one or more hardware memory storage devices, which may be, but are not limited to, hard drives, flash memory, optical discs, RAM, ROM, and/or tapes. Accordingly, the data storage device 208 may be located on the user device 202 or may be functionally coupled to the user device 202 through the network 210.

A non-limiting example of a data base is Filemaker Pro 21, manufactured by Filemaker Inc., 5261 Patrick Henry Dr., Santa Clara, Calif., 95054. Non-limiting examples of a data storage module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 20022.

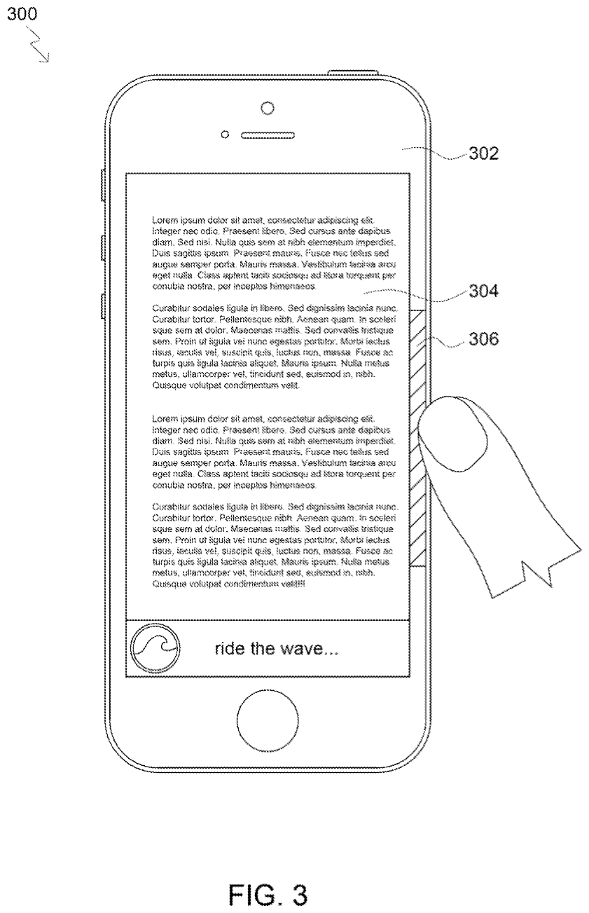

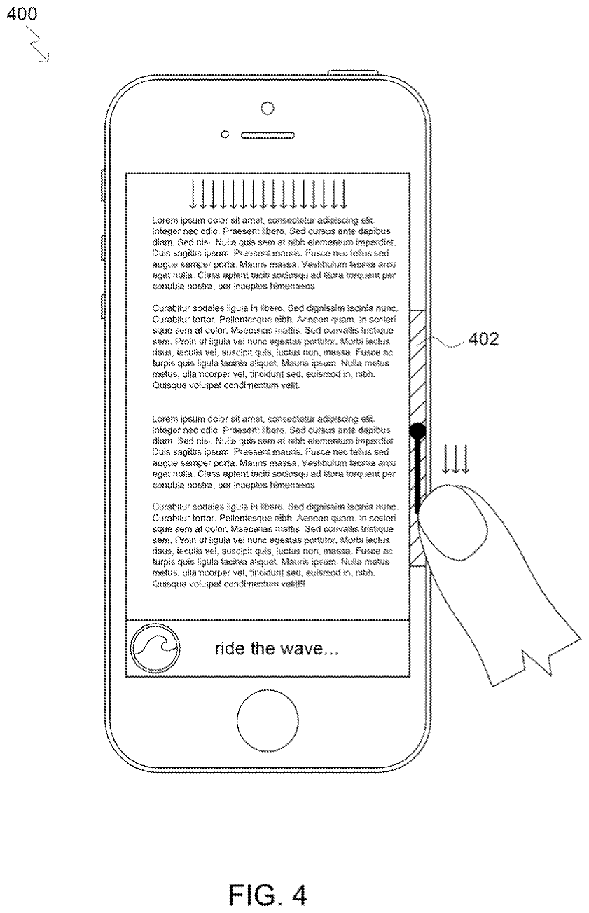

FIGS. 3 and 4 illustrate a hand-held electronic device having a SUI system in operation, according to one embodiment of the invention. FIG. 3 shows a user initially activating the SUI system 300 with an initial touch. Advantageously, a user may seamlessly enable and disable the SUI system 300 at will.

As shown, there is a user device 302 showing content on a user interface 304 as well as an overlay 306 showing that the SUI system has been enabled on the user device. The illustrated user device is a smartphone with a capacitive screen or other touch screen displaying a graphical user interface 304 that allows the user to make selections displayed on the screen by touching the screen with their finger(s). The shown SUI overlay on the user device is an interactive object displayed in association with the content desired to be interacted with by the user.

The illustrated graphic user interface 304 enables the user to interact not only with the content desired to be interacted with, however also with the overlay of the SUI system 300. The graphic user interface 304 receives input from the touch screen when interacted with by the user and displays the corresponding output to the user and as such may submit instructions from the user to the system and may receive feedback from the system with respect to its operation.

The graphic user interface 304 exists in the context of a user device 302 used by a user. The user device generally includes a processor or processing circuitry, a random access memory, data storage devices (e.g., hard, floppy, flash memory, ROM, and/or CD-ROM disk, drives, etc.), data communications devices (e.g., modems, network interfaces, transceivers, cellular network interfaces, etc.), display devices (e.g., LED, OLED, LCD display, etc.), and input devices (e.g., touch screen, buttons, mouse pointing device, keyboard, CD-ROM drive, etc.).

It is envisioned that attached to the user device 302 may be other devices, such as read only memory (ROM), a video card, bus interface, printers, peripheral devices, etc. Those skilled in the art will recognize that any combination of the above components, or any number of different components, peripherals, and other devices, may be used with the user device. The user device operates under the control of an operating system (OS). The operating system is generally booted into the memory of the user device for execution when the user device is powered-on, reset, or otherwise activated. In turn, the operating system then controls the execution of one or more applications. An application, including the OS, can include a graphic user interface, which facilitates interaction of the user with the application. The graphic user interface 304 includes instructions which, when read and executed by the user device through the touch screen or other input, cause the graphic user interface to perform the steps necessary to configure and/or operate the graphic user interface 304 of the application.

The illustrated site content may be of any kind, style, purpose, and the like, including but not limited to text, as illustrated, but also including but not limited to graphics, video, audio, interactive fields, games, sensor displays, and the like and combinations thereof. Such may be embodied as an application, website, web-based application, or the like or combinations thereof. The touch-slide functionality may override existing user-interface controls and such override (initialization and/or cancellation) may be time-based, on application launch, triggered by a previous user selection or the like. The override of the existing user interface may operate as an overlay, as a priority control, a temporary modification of one or more function/object/scripts of the existing user interface, as a disabling of the existing user interface and replacement thereof, as a new instance having a new user interface that imports the previous content and the like and combinations thereof.

The illustrated SUI overlay 306 is shown in FIG. 3 as an outline on the central right-hand portion of the screen. The illustrated overlay 306 is shown to be transparent, such that the user understands that the SUI system 300 is activated and ready to use, and inviting the user to interact therewith, however without interfering with the content the user wishes to view. The SUI system 300 is ready to be activated by the user, or is able to be ignored if the user does not want to interact with it. Accordingly, the SUI system 300 is minimally intrusive and does not otherwise interfere with normal use of the device.

In other embodiments, the SUI system 300 may be constant such that it may not be turned off the device 302. The SUI system 300 may come in many different forms of overlays and positions, some examples being completely invisible with an indicator showing the SUI system 300 is active, some may be overlayed on other areas of the screen. The activation of the SUI system 300 may be from the user device, from a peripheral device, or from an additional input from the user device. A non-limiting example is a curved screen phone, wherein the SUI system 300 may be activated solely from one or both sides of the screen.

In the illustrated embodiment, the user here has decided to use the SUI system 300. As shown, the SUI system 300 has been activated by the user touching the activation area, here shown as the overlay 306. Once the overlay 306 has sensed being touched by the user, the SUI system 300 activates and allows seamless scrolling through constant sliding contact by the user until deactivated. Such deactivation by the user is generally by breaking contact with the touch screen of the device 302. The illustrated SUI system 300 does not show any indication when the overlay is touched, however there may be an indicator that alerts the user when the SUI system 300 is in use.

FIG. 4 illustrates the slide function of the SUI system 400. As shown, the overlay 402 or illustrated interactive object has been touched and held by the user such that contact with the overlay has not been broken. Once the user has touched the overlay, the sliding and/or scrolling process is enabled and by moving up or down with their finger the user may scroll through the content at varying speed.

The activated scrolling is illustrated as an accelerating rate of scrolling. Accordingly, the further the user's finger moves from the initially touched point, the faster the user may scroll in any direction. Such an accelerating system may be exponential, and as the further the user's finger gets, the faster the screen scrolls relative to the distance from the initially touched point (i.e. a quarter inch from the initially touched point may be a screen length every 10 seconds, while a half inch is every 5 seconds, and an inch every second). Other embodiments may instead have a static scroll, where the scroll rate is fixed regardless of distance, or a constant-rate acceleration, where the distance from the user's finger and initially touched point are constant with respect to acceleration (i.e. a quarter inch from the initially touched point may be a screen length every 10 seconds, while a half inch is every 5 seconds, and an inch every 2.5 seconds). The following are non-limiting examples of scroll rate progressions that may be included, solely or in combination (numbers are expressed as x:y wherein x=distance of slide from original touch position and y=scroll rate, units are not necessarily the same between x and y):

| | | Inverse | | | |
|---|---|---|---|---|---|
| Exponential | Linear | Log | Exp-Linear | Logarithmic | Non-linear |
| 1:1 | 1:1 | 1:1 | 1:1 | 1:1 | 1:1 |
| 2:4 | 2:2 | 2:1.5 | 2:2 | 2:10 | 2:3 |
| 3:9 | 3:3 | 3:1.7 | 3:6 | 3:100 | 3:4 |
| 4:16 | 4:4 | 4:1.8 | 4:12 | 4:1000 | 4:9 |

Accordingly, the user may adjust how fast the scrolling takes place dynamically at any moment by shifting their finger(s) from the previous slide position at will. To end the scrolling, the user may simply remove their finger(s) from the device such that contact is broken between the user's finger(s) and the touch screen or other input device. To re-engage the SUI system 400, the user needs simply to put their finger(s) back onto the overlay 402 to create another initial touch point. While the illustrated scrolling is limited to the directions of up and down, it is envisioned that content may be “scrolled” in multiple dimensions where the content itself is presented in multiple dimensions (e.g. may be able to scroll a combination of up, down, left, right depending on the direction and distance of the slide, wherein the content itself is scrollable in such directions). In another non-limiting embodiment, sliding in a direction other than a direction tied to a visually scrollable direction may “scroll” in another dimension. As an example, the content may be scrollable up-down, but if the user actuated slide includes a left-right component it may slide through time (i.e. versions of the content created earlier/later in time). Thus multidimensional scrolling may be effected via the SUI.

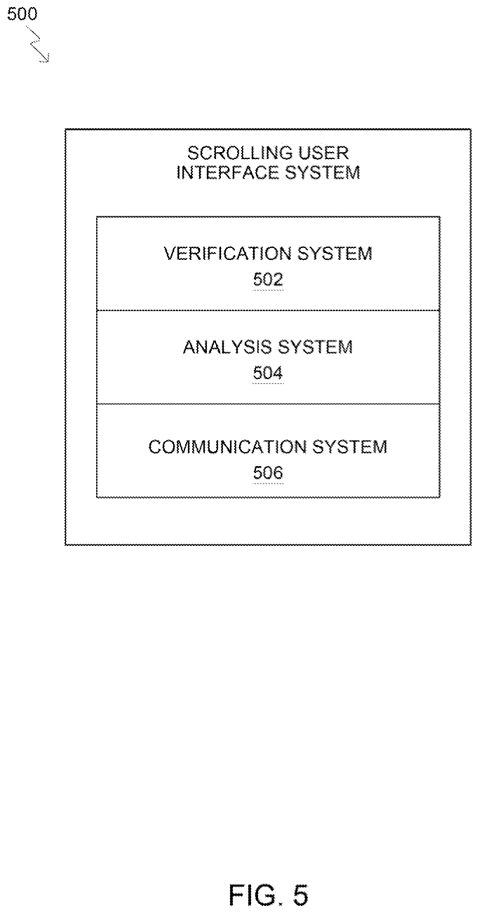

FIG. 5 is a module diagram of a SUI system, according to one embodiment of the invention. As shown, there is a verification system 502, an analysis system 504, and a communication system 506.

The present invention may employ various integrated circuit components, e.g., memory elements, processing elements, logic elements, scripts, look-up tables, and the like, which may carry out a variety of functions under the control of one or more microprocessors or other control devices. Similarly, the software elements of the present invention may be implemented with any programming or scripting language such as but not limited to Eiffel, Haskell, C, C++, Java, Python, COBOL, Ruby, assembler, Groovy, PERL, Ada, Visual Basic, SQL Stored Procedures, AJAX, Bean Shell, and extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like.

The communication systems (hardware and/or software) of the servers/devices described herein provide communication capabilities, such as wireless communication, to the modules and components of the system and the components and other modules described herein. There may be one or more hardware devices such as a network card, system bus, or wireless communication module that may communicate with a computerized network. The communication system may provide communication between a wireless device, such as a mobile phone, and a computerized network and/or to facilitate communication between a mobile device and other modules described herein. The communication system may have a component thereof that is resident on a user's mobile device. Non-limiting examples of a wireless communication module may be but not limited to: a communication module described in U.S. Pat. No. 5,307,463, issued to Hyatt et al.; or a communication module described in U.S. Pat. No. 6,133,886, issued to Fariello et al., which are incorporated for their supported herein.

The processing systems (hardware and/or software) of the servers/devices described herein provide and/or carry out operational instructions and commands to/from the modules and components of the system. The processing system is in communication with the modules and components of the system (and/or other modules described herein) and provides managerial instructions and commands thereto. The source of such instructions/commands may be from one or more other modules described herein and/or through interactions between one or more other modules described herein. The processing system sets parameters and settings for each module and component of the system. Non-limiting examples of a processing system may be a control module described in U.S. Pat. No. 5,430,836, issued to Wolf et al.; or a control module described in U.S. Pat. No. 6,243,635, issued to Swan et al. which are incorporated for their supporting teachings herein. A control module may include but is not limited to a processor, a state machine, a script, a decision tree, and the like.

There may be an SDK that works across multiple platforms that allows developers to incorporate the SUI into operating systems, content batches, and the like. Such may allow for the easy implementation of one or more versions of the SUI described herein.

There may be activation through the capacitive sensor 506 of the user devices to activate it. Tracking of user interaction information may include accelerometer data so one is able to track what angle the device is at. Such may give the content publisher much more eccentric and personable metrics of the user and their interaction(s), thereby helping them to home in on not only what the users want, but what they don't want. Such may track how long the verified interaction increments have lasted in time-stamped blocks of data or how many seconds they interact with the content, via the SUI. There may be a plurality of applications for such a system, including but not limited to: ads, surveys, and fund-raising.

The verification system 502 ensures that the user is actually using the device. The verification system 502 may include an account which may be logged into, or activation of the SUI overlay to enable the system. Further, the verification system 502 may use a sensor to determine angle of device, may use a camera to determine if a user is looking at the screen, and/or may track screen contact on the device to determine if a user is actually using the device. Other verification systems 502 may include a fingerprint scanner, biometric scanners, heat sensors, and/or password protected accounts or logins.

The verification system 502 may allow the SUI system to be used even if it suspects a user is not controlling the device. In such a scenario, it may flag the application such that the device is not counted for advertisement or engagement purposes. Once it has determined a user is using the SUI system, the verification system 502 may automatically unflag the system.

In operation, a user visiting a website or other application with the SUI system 500 enabled may be restricted or flagged by the system depending on if the user device is inclined at a particular range of angles as sensed by the accelerometer, thereby assuring that it is likely that the device is being held by a person's hand. Other methods using other sensors are envisioned, thus improving the quality of data collected by the system and also reducing vulnerability of the system to bots/crawlers/etc.

The analysis system 504 receives information from the touch screen when a user manipulates it by touching it and activating the sensor(s) therein. The analysis system 504 is responsive to the sensor feedback by receiving the information and determining where the screen has been touched by the user via the sensor(s) that determines when touch is broken or remains. When the overlay has been touched, the analysis system 504 places and stores a zero point such that as long as the finger(s) remains pressed, subsequent movements trigger scrolling rates based on the distance from the zero point. Such scrolling rates are increased as the finger moves further from the zero point and are reduced as the finger moves closer to the zero point. If the finger is moved back to the zero point, the scrolling ceases. As exactly hitting the zero point may be difficult, the zero point may have a small buffer or expanded range. The analysis system 504 may only calculate such distance in the y-axis such that movement in the x-axis does not increase scrolling speed.

An example of the analysis system 504 calculation may be that the user touches the screen and marks a zero point. The analysis system 504 measures the finger slide from the zero point. The first tenth of an inch is calculated to remain at zero speed up or down. For every tenth of an inch after that, the analysis system 504 moves in that direction at a rate of one-tenth of a screen per second.

The communication system 506 allows the SUI system to send and receive information to the necessary devices and sensors. Further, the communication system 506 may send and receive user information and data through the network to track how the application was used and/or to aggregate for advertisement, content preference, or other engagement purposes. For example, if the verification system determines that a user is not using the device, it may not collect that usage for any engagement purposes.

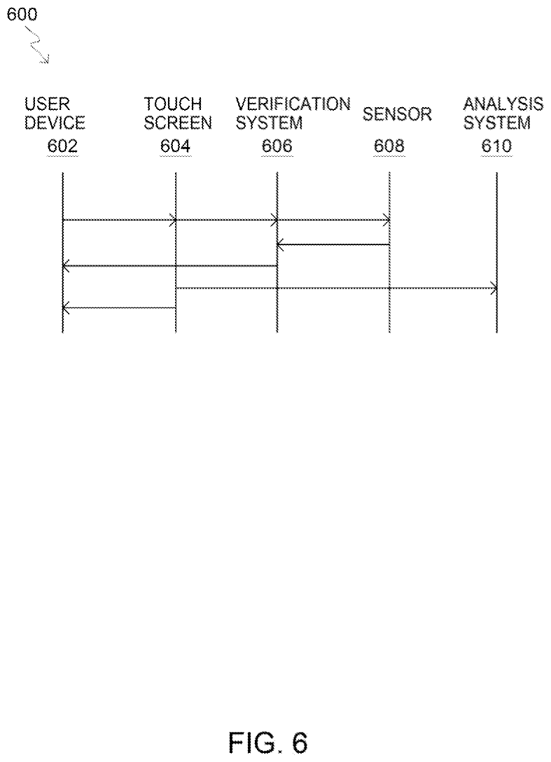

FIG. 6 is a flowchart of a SUI system 600 in operation, according to one embodiment of the invention. The user first uses the user device 602 to open the associated application with the implemented system. The system then enables the overlay and tracking ability of the system. The touch screen 604, verification system 606, and sensor 608 are enabled tracking the movement of the phone, camera, user inputs, and the like and combinations thereof for authentication purposes. The verification system 606 then collects information from the sensor 608 to determine whether a user is using the device 602. The verification system 606 flags the device accordingly depending on what it determines.

The user then uses their finger(s) to touch and activate the touch screen 606. The touch screen 606 sends that input to the analysis system 610, and the system uses that location to set a zero point. The user then slides their finger away from the zero point. The sliding activates the analysis sensor 610 to create a scrolling on the device at a rate depending on the range the finger is from the zero point, and scrolling is controlled accordingly. The touch screen 604 constantly scans in order to determine both where the finger(s) movement is and if the finger(s) continuously remains in contact with the screen 604. The analysis system 610 continuously adjusts the rate of scroll until it senses that contact between the finger and the screen 604 is broken. Once contact is broken, scrolling immediately stops and the analysis system 610 erases the zero point and is reset. The analysis system waits until the touch screen 604 is contacted again on the overlay to enable a new zero point and restart the scrolling.

In some embodiments, the information may be collected by an analytics device. Analytics related to the SUI system may be collected by the analytics device. Advantageously, content providers may be more certain that their content is reaching real people and the interactivity of that content for the users is greatly enhanced. At the same time, content providers can refrain from using intrusive or annoying verification methods. In some embodiments, the system and corresponding overlay is completely invisible to the users, thereby increasing the likelihood of the user willing to interact with the system.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials; shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

1. A scrolling control system, comprising:
a. a user device including a touch sensitive user input device;
b. an analysis system responsive to user manipulation of the touch screen to enter and control an ongoing scrolling mode, the speed and direction of the ongoing scrolling mode speed determined by comparing an initial feedback location with a subsequent feedback location from the touch sensitive user input device such speed and direction of the ongoing scrolling mode continuing the same while the subsequent feedback location continues to register ongoing feedback at the subsequent feedback location; and
c. a verification system that uses captured inputs from the user device to determine if a user is using the input device.

2. The system of claim 1, wherein the user device includes an input device chosen from the group consisting of: an accelerometer, a camera, and a gyroscope, the verification system using the input device feedback as the captured input.

3. The system of claim 1, wherein the user device includes each of: an accelerometer, a camera, and a gyroscope, the verification system using the combined inputs from each as the captured input.

4. The system of claim 1, wherein the verification system flags the input device if it determines a user is not using the scrolling control system, the determination being made while there is feedback from the touch sensitive user input device over a period of time and one of:
the user device being outside of a predetermined angle range; or
the user device not returning any movement over the period of time.

5. The system of claim 1, wherein the verification system collects analytic information, the analytic information including an amount of time the touch sensitive user input device returns feedback that a user is continuously touching the touch sensitive user input device while the user device is returning feedback that it is at a predetermined angle from a horizontal surface perpendicular to a direction of a force of gravity.

6. The system of claim 1, wherein the analysis system maintains the scrolling mode only while feedback from the touch sensitive user input is present and exits the scrolling mode upon sensing no feedback from the touch sensitive user input.

7. The system of claim 1, wherein the speed of the scrolling increases exponentially with the distance between the initial touch location and the subsequent touch location.

8. The system of claim 1, wherein the analysis system is only responsive to user manipulation on a predetermined section of the touch sensitive user input device.

9. A scrolling control system, comprising:
a. a user device including a touch sensitive screen and an input device chosen from the group consisting of: an accelerometer, a camera, and a gyroscope; and
b. an analysis system responsive to feedback from the touch sensitive screen to enter and control a scrolling mode, the speed and direction of the scrolling mode speed determined by comparing an initial feedback location and an current feedback location, wherein the speed and direction of scrolling continues to be the same while the current feedback location continues to be the same.

10. The system of claim 9, wherein the scrolling control system flags the user device if it determines a user is not using the scrolling control system.

11. The system of claim 10, wherein the analysis system enters the scrolling mode upon the sensing an initial touch on the touch sensitive screen.

12. The system of claim 11, wherein the analysis system maintains the scrolling mode only while feedback from the touch screen is present and exits the scrolling mode upon sensing no feedback from the touch screen.

13. The system of claim 12, wherein the analysis system is only responsive to user manipulation on a predetermined section of the touch sensitive screen.

14. The system of claim 13, wherein the scrolling control system includes a verification system that uses captured inputs from the input device to determine if a user is using the input device.

15. A method for electronic scrolling, comprising:
a. detecting an initial input on a user device through a touch sensitive screen;
b. storing the initial input location;
c. detecting a subsequent input on another location of the touch sensitive screen;
d. determining an ongoing scroll rate based on the distance between the initial input and subsequent input;
e. electronically scrolling the information displayed on the touch sensitive screen at the ongoing scroll rate while the subsequent input is unchanged;
f. detecting an absence of an input on the touch sensitive screen; and
g. stopping the scrolling.

16. The method of claim 15, further including the step of determining if a user is using the user device by capturing an input from the user device.

17. The method of claim 15, further comprising a step of continuously adjusting the scroll rate based on the distance between the initial input and further changes to the subsequent input.

18. The method of claim 15, further including the step of using an input device to determine if a user is using the user device.

19. The method of claim 18, wherein the input device is chosen from the group consisting of: an accelerometer, a camera, and a gyroscope.

20. The method of claim 19, wherein the scroll rate exponentially increases with the distance.
